(19) United States
(12) Patent Application Publication
(10) Pub. No.: US 2015/0363737 A1
(43) Pub. Date: Dec. 17, 2015

(54) PERFORMANCE SALES TRACKING FOR A BUSINESS

(71) Applicant: Vivint, Inc., Provo, UT (US)

(72) Inventor: Greg Fairbanks, Cedar Hills, UT (US)

(21) Appl. No.: 14/304,742

(22) Filed: Jun. 13, 2014

(51) Int. Cl. G06Q 10/06; G06Q 20/20; H04M 1/253

(52) U.S. Cl. CPC G06Q 10/06398; G06Q 10/06393; H04M 1/2535; G06Q 20/202

(57) ABSTRACT

A computer-implemented method to automate sales performance analysis for a business is described. Voice over internet protocol (VoIP) data related to the business is observed. The observed VoIP data may be compared with at least one metric associated with the business. The metric may be based at least in part on one or more point of sale metrics, personnel metrics, or profit metrics of the business. The method may determine if the observed VoIP data satisfies the one or more metrics associated with the business. At least one personnel associated with the business may be alerted based at least in part on the determining.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to the computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of technology in everyday life. Advancements in mobile devices and related mobile technology allow users to monitor their location, movement, and/or other aspects of everyday life. As technology expands into homes and businesses, opportunities exist for using technology for alternative purposes such as tasks related to automating sales performance tracking for a business.

### SUMMARY

According to at least one embodiment, a computer-implemented method to automate sales performance analysis for a business is disclosed. The method may comprise observing voice over internet protocol (VoIP) data related to the business. The VoIP data may comprise at least one of a call-length time, a calling number, a call origination, a call destination, a call volume or call metadata. The observed VoIP data may be compared with at least one metric associated with the business. The metric may be based at least in part on one or more point of sale metrics, personnel metrics, or profit metrics of the business. The method may determine if the observed VoIP data satisfies the one or more metrics associated with the business and may alert at least one personnel associated with the business based at least in part on the determining.

In further embodiments, the point of sale data may be captured. The point of sale data may comprise at least one of items or services purchased, an amount of the purchase, a time of the purchase, and a discount or sale associated with the purchase. The method may compare point of sale data to the observed VoIP data and correlating the VoIP data to the point of sale data based on the comparing. In some embodiments, the method may generate a report outlining the correlations.

In further embodiments, the method may compare the VoIP data to a work schedule. The work schedule may comprise at least scheduling information for one personnel associated with the business. The method may develop a performance report based on the comparing. The method may update a profile associated with at least the one personnel based on the developing and determine a score associated with the updating. In some embodiments, the method may update the profile associated with the at least one personnel based on the determined score.

In alternative embodiments, the method may record the VoIP data based on the observing and generate at least one report based on the recording. The at least one report may be distributed to at least one personnel associated with the business. In further embodiments, it may be determined if the observed VoIP data exceeds the one or more metrics associated with the business and the at least one personnel associated with the business may be alerted based at least in part on the determining.

In further embodiments, the method may identify an unpredicted change in the point of sale data. The change may comprise one of a fluctuation in an aggregate monetary value of sales or a total number of sales. The method may correlate the unpredicted change in point of sale data with the VoIP data and record the unpredicted change in a database with the correlating VoIP data. In some embodiments, the method may adjust business metric goals based at least in part on the correlating. The method may also review the database for historical information and generate a report to send to the at least one personnel associated with the business. The report may contain the historical information for an upcoming time period.

In some embodiments, the method may capture point of sale data, wherein the point of sale data includes items purchased, cost of items purchased, and a relationship between the items purchased and may compare the point of sale information to a work schedule. The method may determine one or more trends between the point of sale data and the work schedule, wherein the one or more trends captures profits or losses of the business.

In further embodiments, the method may alert a supervisor of the business based on the determining, wherein alerting the supervisor comprises displaying the alert on a dashboard associated with the business. In further embodiments, the business metrics may additionally comprise at least one of a number of sales, a change in sales, a profit, or a volume of calls based on daily, weekly, or monthly totals.

According to another embodiment, an apparatus to automate sales performance analysis for a business is also described. The apparatus may include a processor, a memory in electronic communication with the processor and instructions stored on the memory of the processor. The processor may execute the instructions to observe customer data related to the business. The customer data may comprise at least one of a number of customers, customer purchases, or customer traffic. The processor may execute the instructions to observe voice over internet protocol (VoIP) data related to the business. The VoIP data may comprise at least one of a call-length time, a calling number, a call origination, a call destination, a call volume or call metadata. The observed VoIP data may be compared with at least one metric associated with the business. The metric may be based at least in part on one or more point of sale metrics, personnel metrics, or profit metrics of the business. The instructions may determine if the observed VoIP data satisfies the one or more metrics associated with the business and may alert at least one personnel associated with the business based at least in part on the determining.

According to another embodiment, a computer-program product to automate sales performance analysis for a business is also disclosed. The computer-program product may include a non-transitory computer-readable medium that may store instructions executable by a processor. The instructions observe voice over internet protocol (VoIP) data related to the business. The VoIP data may comprise at least one of a call-length time, a calling number, a call origination, a call destination, a call volume or call metadata. The observed VoIP data may be compared with at least one metric associated with the business. The metric may be based at least in part on one or more point of sale metrics, personnel metrics, or profit metrics of the business. The instructions may determine if the observed VoIP data satisfies the one or more metrics associated with the business and may alert at least one personnel associated with the business based at least in part on the determining.

The foregoing has outlined rather broadly the features and technical advantages of examples according to the disclosure such that the following detailed description may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an environment in which the present systems and methods may be implemented;

FIG. 2 is a block diagram of an example of another environment in which the present systems and methods may be implemented;

FIG. 3 is a block diagram of an example automated schedule module of the environments shown in FIGS. 1 & 2;

FIG. 4 is a block diagram of an example scheduling module of the environment shown in FIG. 3;

FIG. 5 is a block diagram of an example business metrics module of the environments shown in FIGS. 1 & 2;

FIG. 6 flow diagram illustrating a method to automate scheduling for a business;

FIG. 7 is a flow diagram illustrating another method to automate scheduling for a business;

FIG. 8 is a flow diagram illustrating an exemplary method of finding an auxiliary personnel;

FIG. 9 is a flow diagram illustrating another method to automate performance sales tracking for a business;

FIG. 10 a block diagram of a computer system suitable for implementing the present systems and methods of FIGS. 1-9;

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to automated sales performance tracking. More specifically, the systems and methods described herein relate to an automated system for tracking voice over internet protocol (hereinafter “VoIP”) within a business context and correlating the VoIP data to different business metrics. In some instances metrics may be thresholds or parameters which may be exceeded or satisfied. Alerts may be electronically sent to alert when thresholds are satisfied. In one example, VoIP data may be observed and recorded including at least a number of calls, length of call, average call time, call origination, call destination, and the like. In another embodiment, personnel may be alerted if VoIP data reaches set thresholds or parameters.

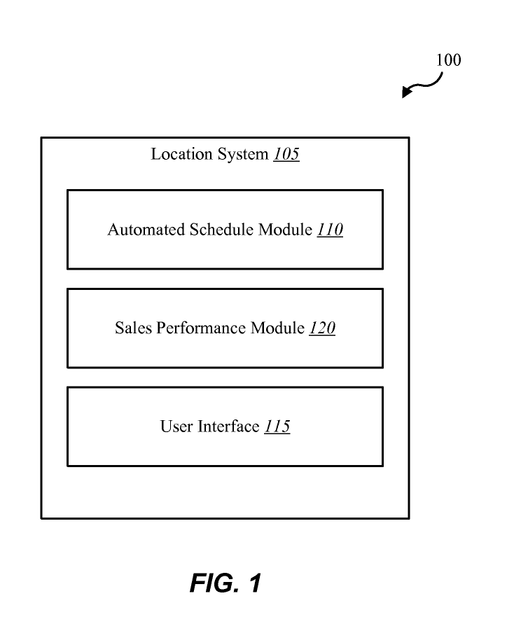

FIG. 1 is a block diagram illustrating one environment 100 on which the methods and disclosure may be implemented. The environment 100 may include a location system 105. The location system 105 may include an automated schedule module 110, a sales performance module 120, and a user interface 115. While FIG. 1 shows the automated schedule module 110, the sales performance module 120, and the user interface 115 included within the location system 105, these and other components of the environment 100 may be housed separately and operate independently while still working cooperatively with each other and other components of the location system 105.

The location system 105 may be associated with a commercial entity. For example, the location system 105 may be located at a business. The business may have at least one personnel associated with it. In some embodiments, the personnel may be an employee. The business may be any commercial business. In some instances, the business may be a law firm, an accounting firm, a service provider, a warehouse, a health-care provider, and the like. In some instances, a location system 105 may be present at multiple different locations associated with the same business. For example, the business may be part of chain, may have satellite offices, or the like. In other examples, the business may have multifunctional locations. For example, a business may have a warehouse, a manufacturing facility, an office space, a testing space and/or any combination thereof. In those embodiments, the environment 100 may have multiple location systems 105 for each business location. In other embodiments, one location system 105 may be present at a single location and may service all of the business's locations. When the term business is used herein, it encompasses all types of non-residential locations.

The location system 105 may be controlled by an administrator. The administrator may be a supervisor, personnel, business owner, CEO, employee, or some other professional associated with the location. In some embodiments, multiple people may be the administrator. For purposes of clarity, the term administrator used herein may encompass either a single individual or multiple individuals with equal access to the location system 105, personnel scheduling duties, and access to business metrics.

The automated schedule module 110 may be configured to observe and learn from the actions of personnel associated with the business and to create a schedule optimized for business needs. In some embodiments, personnel may interact with scheduling system via a mobile device. For purposes of clarity, personnel may refer to single personnel or multiple personnel. Personnel may include full or part-time employees, contractors, temporary workers, seasonal workers, apprentices, interns, trainees and the like. Additionally, the term manager may encompass a supervisor, business owner, administrator, or any personnel in charge of staffing solutions and capable of accessing business metrics. While the term manager will be used, it will be understood that it may encompass multiple managers.

In some embodiments, the automated schedule module 110 may be a mostly automated system requiring little to no external input. In other embodiments, the automated schedule module 110 may receive varying levels of input to shape and customize the automated schedule module 110 to meet the business needs. The user interface 115 may interact with the automated schedule module 110 and receive manager preferences, personnel preferences, business information and the like. In other embodiments, the user interface 115 may be integrated with the personnel's device or a manager's device.

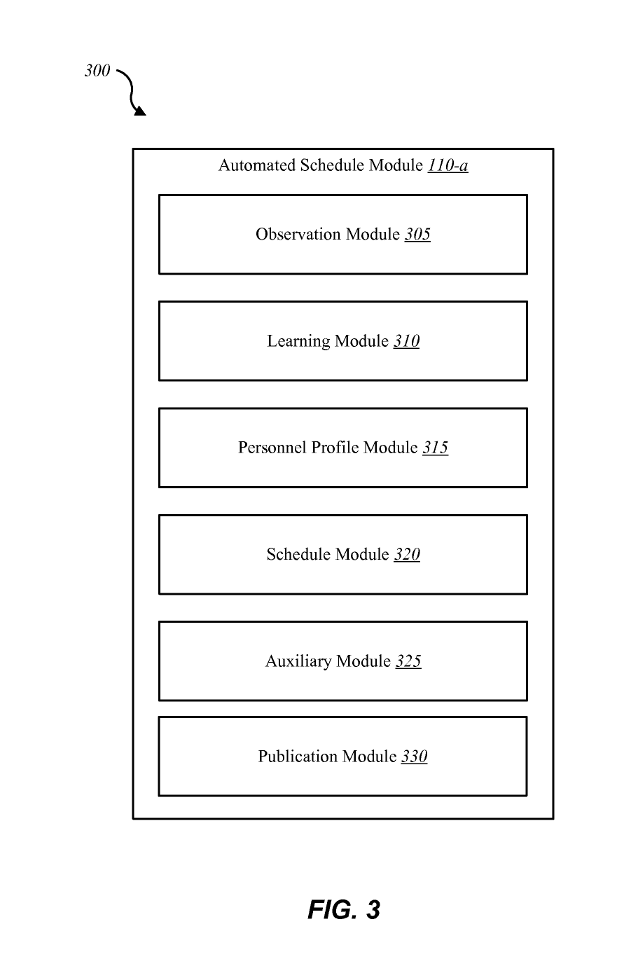

The automated schedule module 110, in addition to automating a work schedule, may have the capability to store and analyze personnel data, track business efficiency and profitability and other functions as described in further detail below with reference to FIG. 3. The automated schedule module 110 may also be capable of receiving communications from a remote device in response to the work schedule. The automated schedule module 110 may perform additional functions as discussed herein.

In some embodiments, the sales performance module 120 may be a mostly automated system requiring minimal input, or in some instances, may be a completely independently operational module. The sales performance module 120 may track and record sales performance in associated with business metrics. In some embodiments, the sales performance module 120 may allow a manager to determine which metrics are tracked. The metrics may include metadata associated with VoIP metrics. In other embodiments, the sales performance module 120 may present a menu or the like and allow a manager to optionally choose which metrics to track. In some embodiments, the sales performance module 120 may additionally allow personnel to set the types of alerts managers receive. In other embodiments, the alerts may be preprogrammed and the manager may set the thresholds or parameters which may trigger the alerts.

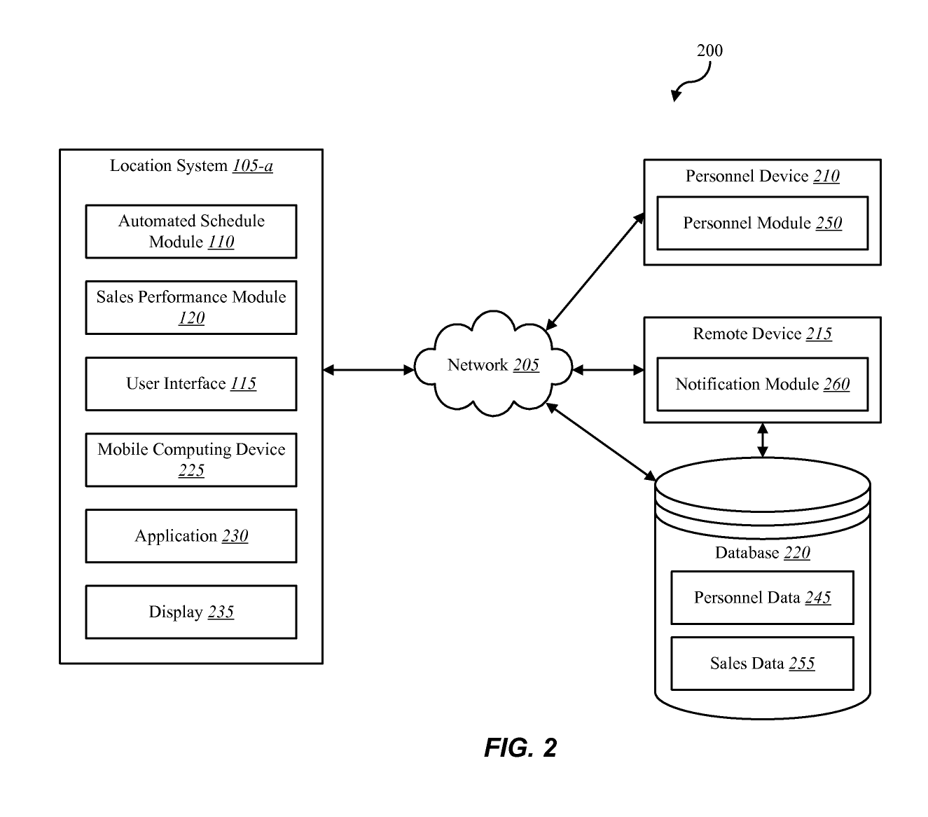

Referring now to FIG. 2, in some embodiments, an environment 200 may include the components of environment 100 described above, and may further include a network 205, a personnel device 210, a remote device 215, and a database 220. The location system 105-a may be one example of the location system 105 described above with reference to FIG. 1. The location system 105-a may include, in addition to the automated schedule module 110 and the user interface 115, a mobile computing device 225, an application 230, and a display 235. A database 220 may include (e.g., store) personnel data 245 and/or sales data 255.

The location system 105-a may include various components and functionalities that work cooperatively with the automated schedule module 110, the sales performance module 120, and the user interface 115, and/or may operate independently of the automated schedule module 110, the sales performance module 120, and the user interface 115. In some embodiments, the application 230 may use the location system 105-a to perform tasks related to the automated schedule module 110 and/or the sales performance module 120.

In some embodiments, the mobile computing device 225 may include one or more processors, one or more memory devices, and/or a storage device. Examples of the mobile computing device 225 may include mobile computing devices, smartphones, personal computing devices, computers, servers, etc. The mobile computing device 225 may be operable independent of features of the automated schedule module 110, the user interface 115, and the sales performance module 120. Alternatively, at least some functionality of the mobile computing device 225 may cooperate with and/or interface with the automated schedule module 110, the user interface 115, and/or the sales performance module 120.

The application 230 may allow a user or manager to control (either directly or indirectly) an aspect of the property where the location system 105-a is located. In some configurations, the application 230 may also interface between, for example, the automated schedule module 110, the sales performance module 120, the user interface 115, the mobile computing device 225, or the display 235. Thus, the application 230, via the user interface 115, the display 235, and/or the mobile computing device 225, may allow managers to automate business metric tracking. Information or data associated with the application 230 and its operation may be saved according to the data storage methods described herein.

In some embodiments, a user may access the functions of the location system 105-a from the mobile computing device 225. For example, in some embodiments, the mobile computing device 225 includes a mobile application that interfaces with one or more functions of the location system 105-a (e.g., automated schedule module 110/sales performance module 120). Examples of the mobile computing device 225 may include a personal computing device (e.g., a laptop, desktop, etc.), a mobile computing device (e.g., tablet computing device, smartphone, etc.), and the like. The automated schedule module 110, the sales performance module 120, and/or the user interface 115 may be integrated with the mobile computing device 225 in the form of one or more personal computing devices (e.g., mobile devices, smartphones, and/or personal computing devices) to control aspects of the location and/or monitor activities of personnel (e.g., clock-in, clock-out, perform duties, job performance, scheduling, receive business metric alerts, etc.).

In some embodiments, the personnel device 210 may be a mobile device unique to a particular personnel. The personnel device 210 may include, for example, a personal computing device (e.g., laptop), a mobile computing device (e.g., tablet computing device, smartphone, etc.), a wearable device, a multi-purpose portable device, a multi-purpose pocket computer, or the like. The personnel device 210 may be in communication with the automated schedule module 110, the sales performance module 120, or other features and components of the location system 105-a via, for example, the network 205. The personnel device 210 may be capable of two-way communication with the automated schedule module 110, the sales performance module 120, and other features of the location system 105-a including, for example, receiving notifications from and sending information (e.g., notifications, time entry information, schedule information, auxiliary shift options, etc.) back to the automated schedule module 110, the sales performance module 120, or other features of the location system 105-a. The personnel device 210 may include a display and/or user interface. Notifications may be received on the personnel device 210 in the form of, for example, a text message, email, audible signal, picture, ping message, etc. The notifications received at the personnel device 210 may be in response to scheduling data which is generated via the automated schedule module 110, the sales performance module 120, and/or the user interface 115 and delivered to the remote device 215 and/or the database 220, or directly to the personnel device 210. The personnel device 210 may also include storage capability to store data such as personnel work data, notifications, schedules, contact information, and the like associated with their employment.

In some embodiments, the personnel device 210 may interact with the location system 105-a via an personnel module 250. The personnel module 250 may be configured to receive a work schedule from the automated schedule module 110 and/or the sales performance module 120. The personnel module 250 may also interact with the automated schedule module 110 and send information such as sick time, vacation days, and the like. In further embodiments, the personnel module 250 may enable personnel to confirm auxiliary staff. The personnel module 250 may also enable personnel to receive notifications of upcoming shifts, interactions with the manager, and other information relating to the business. In some embodiments, the personnel module 250 may interact and receive alerts from the sales performance module 120. For example, the personnel module 250 may receive work alerts from the sales performance module 120. The work alerts may comprise warnings such as exceeding length of call time, too many calls made, not enough calls made, duration of calls too short, and the like. In some instances, the personnel module 250 may send and receive other alerts and/or message from the sales performance module 120.

In some embodiments, the remote device 215 may also communicate with the automated schedule module 110, the sales performance module 120, and other features and components of the location system 105-a via, for example, the network 205. The remote device 215 may be any of a number of electronic devices including, for example, a dedicated automation computing device (e.g., wall-mounted controller), a personal computing device (e.g., laptop, desktop, etc.), a mobile computing device (e.g., a tablet computing device, smartphone, etc.), and the like. The remote device 215 may be located physically away from the location system 105-a or components thereof such as, for example, the user interface 115. The remote device 215 may be accessed by, for example, a manager or other personnel associated with the place of business. The remote device 215 may be configured for two-way communication with the automated schedule module 110, the sales performance module 120, and other features of the location system 105-a. The remote device 215 may receive notifications and information associated with personnel, customers, scheduling, and the like (e.g., personnel data, work schedule, auxiliary staffing data, abnormal customer data, abnormal VoIP data, etc.). For example, the remote device 215 may contain a notification module 260. The notification module 260 may be configured to exchange alerts and/or message with the sales performance module 120. For example, the notification module 260 may receive alerts relating to sales parameters such as aggregate sales performance, slow sales performance, increase in sales, quantifiable purchases made, and the like

The personnel data 245 may be accessed directly from the database 220, from the personnel device 210 via, for example, the network 205 and/or the automated schedule module 110, the sales performance module 120, or other components of the location system 105-a. The personnel data 245 may be in the form of raw data such as, for example, staffing requirements, personnel profiles, and/or historical profit information. For example, the personnel profile may include information such as role, pay scale and a score associated with personnel. The personnel data 245 may also include more detailed information. For example, it may include staffing schedules and may record the punctuality, reliability, and performance of the personnel. For example, some personnel may be habitually late and constantly calling in sick. The personnel data 245 may record each instance and use the information to generate a score associated with the personnel. The personnel data 245 may also include information regarding performance. For example, the personnel may be consistently improving and taking on new roles at the business. The personnel may additionally cause an increase in sales or customer satisfaction.

In further embodiments, the sales data 255 may be accessed directly from the database 220, from the personnel device 210 via, for example, the network 205 and/or the automated schedule module 110, the sales performance module 120, or other components of the location system 105-a. The sales data 255 may be in the form of raw data such as, for example, point of sale, purchases, profits, personnel performance, time of sale, and/or historical customer information. The sales data 255 may also include more detailed information. For example, it may store data relating to number of sales onsite, online purchases, phone orders, or the like. The sales data 255 may record historical business information such as purchase data, VoIP data, and correlating trends. The sales data 255 may also correlate personnel to sales data. For example, some personnel may generate more revenue than others.

The remote device 215 may include a user interface, storage capability, and other features and functionalities that permit the remote device 215 to not only receive notifications and data, but to also send instructions, data, notifications, and the like. The remote device 215 may receive personnel profiles, staffing needs, automate a schedule, receive customer data, communicate with the location system 105-a, and store relevant information in a database (e.g., in database 220). The remote device 215 may also send notifications to the personnel device 210, the automated schedule module 110, the sales performance module 120, or other components of the location system 105-a, or to another location or remote device 215.

The network 205 provides communication via, for example, wired or wireless connections. Further, the network 205 may include a plurality of communication mediums. For example, the network 205 may include different communication mediums to provide communication between the automated schedule module 110, the sales performance module 120, and/or other components of the location system 105-a and other devices such as the personnel device 210, the remote device 215, and the database 220. Examples of the network 205 may include cloud networks, local area networks (LAN), wide area networks (WAN), virtual private networks (VPN), wireless networks (using 802.11, for example) and/or cellular networks (using 3G and/or LTE, for example), etc. In some embodiments, the network 205 may include the internet.

FIG. 3 is a block diagram 300 illustrating one example of an automated schedule module 110-a. The automated schedule module 110-a may be one example of the automated schedule module 110 depicted in FIGS. 1 and/or 2. As depicted, the automated schedule module 110-a may include an observation module 305, a learning module 310, a personnel profile module 315, a schedule module 320, an auxiliary module 325, and a publication module 330. Other embodiments may include additional or, in some embodiments, less modules than that which is shown in FIG. 3.

In some embodiments, the observation module 305 may observe personnel actions and scheduling. Personnel actions may include at least one of the performance, timeliness, and reliability. For example, the observation module 305 may observe clock-in and clock-out information. The observation module 305 may compare the clock-in and clock-out information with the scheduled shift times. The observation module 305 may record if the personnel is punctual, tardy, or the like. The observation module 305 may further track the consistent behavior of the personnel to note if personnel is habitually tardy or habitually punctual and may disregard sporadic tardy days for a habitually punctual personnel. In some embodiments, the observation module 305 may gather VoIP data relating to the personnel and gather information regarding the personnel's performance via telephony sales.

In some embodiments, the observation module 305 may also observe and/or record the performance of the personnel. For example, the personnel may cause an increase in business efficiency or sales. For example, in a small business, the observation module 305 may notice a member of the staff consistently generates telephony sales. In contrast, the observation module 305 may also observe a personnel who generates little to no telephony sales. In other embodiments, the observation module 305 may realize an increase in sales of products or services associated or attributed to a particular personnel. The observation module 305 may also realize and observe advancing or improving skillset. For example, a beginner may make fewer mistakes or show a potential to increase their responsibilities.

In further embodiments, the observation module 305 may observe the reliability of personnel. For example, one or more personnel may consistently call in sick or have unscheduled emergencies and/or days off. In some instances, personnel may fail to call-in sick or otherwise notify the business of a pending absence. The observation module 305 may record the absences. For example, the observation module 305 may determine a particular personnel consistently calls in sick every third Thursday of the month. The absences may be observed and recorded and may determine there is a pattern. Additionally, frequent absences may cause an alert to be sent to a manager.

The observation module 305 may additionally observe existing work scheduling practices. For example, the observation module 305 may observe shift start and end times, shift overlap, combinations of personnel scheduled, and the like. For example, the observation module 305 may determine the shift start and end times for specific personnel, specific roles scheduled, or a combination of both. Additionally, the shift start and end times may differ depending on day of the week, or other external factors such as seasonal changes. In some embodiments, combinations of personnel scheduled may include the different roles of the personnel scheduled and/or the actual personnel combinations that are scheduled. For example, the observation module 305 may determine the number of cashiers, telephony sales personnel, shipping personnel, and the like. The observation module 305 may also determine the specific personnel scheduled to work.

In some embodiments, the observation module 305 may compare the personnel and scheduling observations with a profit, efficiency, or other business metrics. For example, the observation module 305 may determine a specific combination of personnel roles leads to a greater profit during the scheduled shift. The specific combination of personnel may maximize efficiency while still meeting customer needs. In another embodiment, the observation module 305 may determine an increased profit or efficiency with a specific combination of personnel. The specific personnel may work more cohesively or effectively to the benefit of the business. For example, a specific combination of personnel at a small business may work more effectively to complete sales calls and fulfill orders, thus increasing the profits realized. The observation module 305 may also track an increase in sales when specific sales personnel work together on the projects.

Conversely, the observation module 305 may also determine when a combination of personnel decreases the efficiency or profitability of the business. For example, in some embodiments, a specific combination and number of personnel roles may decrease the efficiency or profitability of the business. For example, there may be too many telephony sales personnel scheduled to work at a business during a timeframe when telephonic sales are typically low. Additionally, the observation module 305 may observe when a combination of specific personnel leads to a decrease in efficiency or profitability. For example, two specific personnel may converse during their shift, ignoring their duties. This may reflect a decrease in expected sales every time the two sales personnel are jointly scheduled. Additionally, in some instances, some personnel may have an abrasive relationship when scheduled jointly which may detrimentally affect the business. For example, two staff members may bicker and not work cohesively to finish a job and may delay orders. The observation module 305 may observe and track this type of information.

In some embodiments, the observation module 305 may collect historical scheduling information or other information relating to the business. For example, the observation module 305 may receive information regarding historical shift scheduling, salary information, accounting information, personnel information and the like. The information may be uploaded into the observation module 305 or otherwise received and analyzed by the observation module 305. In further embodiments, the observation module 305 may collect historical information such as seasonal information, market information, or previous sales information. For example, the observation module 305 may observe market fluctuations based on external forces such as weather, world events, or the like. The observation module 305 may additionally observe and analyze previous sales information and may determine a pattern or other characteristics of pervious sales. In some embodiments, the information may be gathered and compared to other gathered data to determine correlations between work schedules, market fluctuations, seasonal impacts, and the like.

The learning module 310 may use the information from the observation module 305 to develop parameters and the like. For example, the learning module 310 may learn the scheduling needs of the business based on the observations and set forth certain parameters or rules for drafting and/or producing the work schedule and/or the shift requirements. The learning module 310 may optimize shift changes, or any necessary overlap between personnel for a cohesive business unit. Additionally, the learning module 310 may implement rules where certain personnel are either to be scheduled together as frequently as possible or never be scheduled together.

As the learning module 310 becomes more sophisticated and refined, it may begin to implement changes. The changes may be acutely observed by the observation module 305 to determine their success or lack thereof. For example, the learning module 310 may increase or decrease staff based on a series of observations. The learning module 310 may implement this change and observe for a period of time before determining its success or failure. In some embodiments, the learning module 310 may automatically implement changes into the automated schedule module 110-a. In further embodiments, a manager may need to approve the changes before they are implemented. Further, the learning module 310 may only implement small, incremental changes, or may implement larger scale scheduling changes to optimize profit, efficiency, and other business metrics.

The personnel profile module 315 may record and retain profile information associated with personnel. The profile information may contain at least some information gathered by the observation module 305. For example, the personnel profile may include a score, pay scale, a role, and the like. The personnel score may track and evaluate individual personnel. The personnel score may be based at least in part on the personnel's attendance, proficiency, efficiency, profitability, timeliness, and the like. The personnel score may help the business determine the worth of the personnel and may also aid in scheduling. For example, it may not be desirable to schedule a shift consisting only of personnel with subpar ratings. Rather, it may be desirable to have a balanced number of personnel from multiple scoring levels. In further embodiments, personnel with superior ratings may receive more desirable shifts, an increased quantity in shifts, and the like. Additionally, personnel with superior ratings may receive bonuses, raises, or other forms of compensation.

In further embodiments, the personnel profile module 315 may contain pay scale information. For example, a personnel may have an hourly rate or some other quantifiable cost associated with them. In other embodiments, the personnel profile module 315 may track a base pay scale information and also commissions earned based on sales. This information may be stored within the personnel profile and may aid in creating a schedule or assigning personnel to specific clients, regions, or sales teams. Other information which may be included in the personnel profile may include the personnel role, the personnel proficiency, the personnel's seniority, a profitability rating, and the like. A profitability rating may include either the ability of the personnel to make a sale, complete a job in an efficient manner, or some other quantifiable measure of profitability relating to the particulars of the business.

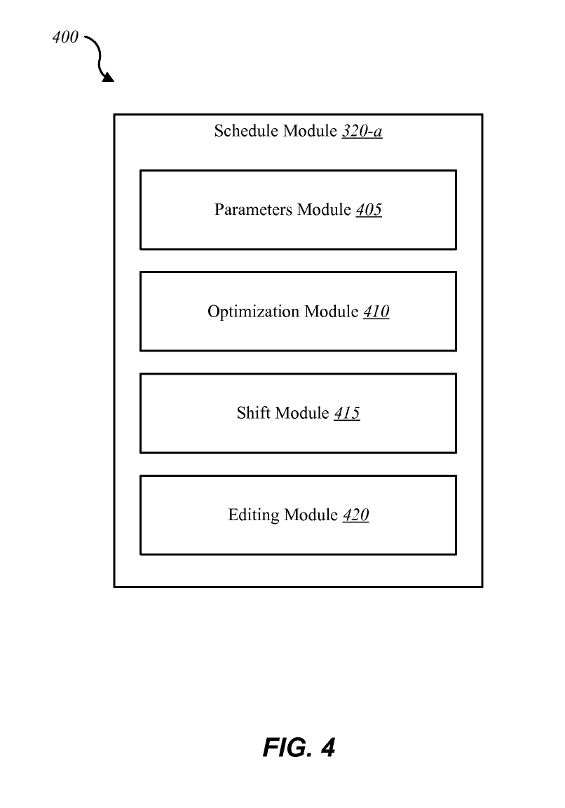

FIG. 4 is a block diagram 400 illustrating one example of a schedule module 320-a. The schedule module 320-a may be one example of the schedule module 320 displayed in FIG. 3. The schedule module 320-a may generate a work schedule for a business. The schedule may be applicable to a number of industries and types of businesses or commercial locations. As depicted, the schedule module 320-a may include a parameters module 405, an optimization module 410, a shift module 415, and an editing module 420. Other embodiments may include additional or fewer capabilities than those illustrated in FIG. 4.

The parameters module 405 may be configured to set different parameters for each shift or each particular job of the business. Parameters may include minimum number of personnel, roles of personnel, profitability of the personnel, and the like. The minimum number of personnel may combine with the personnel role to ensure every facet of the business is adequately staffed. For example, a business may require a number of personnel to pull supplies and then a different number of personnel to package supplies, and a third number of personnel to ship the packages. In another embodiment, a sales team may require personnel with different backgrounds or duties to help close a sale and service a client, etc. The number of each may vary depending on the size of the job, type of job, the location of the job, and the customer's parameters. In some embodiments, the time of day, or timing of the project may affect the scheduling parameters. For example, more telephonic sales personnel may be needed one day, whereas the next, the business may require packagers to aid in shipping orders. Additionally, in some embodiments, a job may require more sales personnel to contract business and then support personnel to fulfill the contract. In other embodiments, the business may require different numbers or types of personnel depending on the time of day. For example, a business may require an increase in staffing during the daytime hours and then a decrease in staffing after hours.

The parameters module 405 may also set rules such as specific personnel to group together or to separate. For example, the observation module 305 (FIG. 3) may determine a combination of personnel is more efficient or profitable and, conversely, another combination of personnel is detrimental to the success of the business. The parameters module 405 may set rules surrounding these individual personnel to maximize business profitability and efficiency. In some embodiments, the parameters module 405 may set a threshold for minimum personnel scheduled for each shift and/or job. The minimum personnel may be a correlation to historical information wherein the required personnel and expected sales maintains a predetermined ratio. In some embodiments, the number of sales may be tracked (e.g. by the sales module 510) and may be compared to the number of personnel scheduled for the shift or job. If the sales exceeds the expected amount, or if the ratio of personnel to sales exceeds a threshold, an alert may be sent to a manager of the personnel. The alert may simply notify of an upcoming expected shortage, that the ratio has been exceed, or the like. In some embodiments, the manager may use an auxiliary module (e.g. auxiliary module 325) to locate auxiliary personnel to supplement the needs of the business.

The parameters module 405 may also set parameters for each shift wherein the parameters include at least a required number of personnel from predetermined score ranges. For example, the learning module 310 (FIG. 3) may determine and/or set predetermined personnel score ranges. The ranges may categorize personnel such as on a 1-10 scale or may set a naming categorization such as fundamental, novice, intermediate, advanced, and expert. The parameters module 405 may then have a required mixture or threshold of personnel from the different competencies. For example, every shift may be required to have at least one expert personnel in each personnel role scheduled. Or, only certain shifts may have this requirement, for example, a business may require an expert sales personnel for important business leads but may only require an advanced or intermediate sales personnel for smaller business leads. In additional embodiments, the parameters module 405 may set a threshold of scores for shifts or jobs. For example, a shift may require a combined score such as 50. Then the personnel for the shift must have a combined score that meets or exceeds the score of 50. For example, scheduling 5 personnel for the shift with a score of 10 would meet the threshold. Other combinations of personnel and shift requirements may also meet the combined the score. The combined score or threshold may ensure the shift is adequately staffed to support the shift needs.

In further embodiments, the parameters module 405 may identify personnel scores within a predetermined range of scores. Personnel who have scores within the predetermined range may be scheduled for preferred shifts. For example, if personnel have a score ranging from 5-10, or intermediate—expert, may submit requests for their preferred shifts. The preferred shifts may be better working hours, more profitable shifts, or the like. The parameters module 405 may set parameters to provide preferential treatment to deserving personnel. Preferred personnel may also determine which customers they prefer to cover, which geographic regions, and the like.

The optimization module 410 may review the requirements set in the parameters module 405 to ensure the schedule is optimized for profitability and efficiency. For example, the optimization module 410 may ensure certain personnel are not scheduled for overtime, or the overtime is limited to a profitable range. In some embodiments, the optimization module 410 may also ensure personnel are widely disbursed to ensure commission compensation is adequately spread across all personnel. Additionally, the optimization module 410 may review a schedule to ensure the pay-scale of the personnel scheduled is optimized for efficiency and profitability. For example, the optimization module 410 may balance the personnel score with the personnel pay-scale. By balancing pay ranges with scores, the optimization module 410 may maximize profitability or other desirable business metrics.

In further embodiments, the optimization module 410 may balance the different ranges of personnel. For example, the optimization module 410 may determine a preferred range of personnel from different score ranges and/or rankings. The preferred range may be a combination of personnel to ensure beginner or novice personnel have the ability to learn from senior personnel. Additionally, the senior personnel may be adequately staffed to ensure the beginner or novice personnel receive adequate training while still achieving business goals.

The shift module 415 may create the shifts and compile a work schedule for the business. In further embodiments, the shift module 415 may also create a team of personnel to tackle a new customer, client, or other job. When creating the schedule, the shift module 415 may use the parameters module 405 and optimization module 410 to ensure the schedule created was optimized to meet the business needs. In some embodiments, the shift module 415 may additionally base the schedule off of personnel preferences. For example, personnel may have the ability to submit preferred shifts, preferred days off, preferred roles, and the like. The shift module 415 may consider the preferences when forming the shifts and overall work schedule. In some embodiments, preferential personnel (personnel with preferred scores) may receive their requests before other personnel. The shift module 415 may produce a work schedule for a predetermined time period. For example, the shift module 415 may produce a work schedule for a day, two days, a week, two weeks, etc. Once the shifts and schedules are created, the shift module 415 may send the schedule to a manager for approval.

The editing module 420 may enable the manager to edit and approve the work schedule created by the shift module 415. In further embodiments, any personnel associated with the business may edit and approve the work schedule. Manager is used generally herein. In some embodiments, the manager may manually make the changes to the schedule and approve it. In other embodiments, the manager may request the schedule module 320-a to redo the schedule based on certain parameters and/or feedback. If a business has multiple managers, the editing module 420 may enable the responsible managers to edit and review only their shifts. However, the schedule module 320-a may coordinate with other managers to ensure all staffing needs are met. Once all edits and approvals are received, the editing module 420 may produce a final work schedule. Conversely, the editing module 420 may relay information to the shift module 415, which may produce a final work schedule.

In some embodiments, a manager's actions may also be observed and recorded (by, for example, the observation module 305, FIG. 3). If manager shows preferential or discriminatory treatment of personnel, the manager may receive a warning. In some embodiments, these actions may cause the schedule module 320-a to alert the manager's supervisor concerning their actions.

Returning back to FIG. 3, the auxiliary module 325 may produce a list of auxiliary shift options. The auxiliary shift options may include at least a list of acceptable auxiliary personnel. The auxiliary personnel may be general auxiliary personnel or may be specific to particular roles and job functions of the personnel. In some embodiments, a scheduled personnel may have access to the list. For example, the auxiliary module 325 may publish and/or send the list to the scheduled personnel, manager, and the like. If a scheduled personnel is incapable of working, the personnel may contact an auxiliary personnel asking if they will work the upcoming shift. In some embodiments, the scheduled personnel and auxiliary personnel may interact using the personnel module 250 on the personnel device 210. The auxiliary personnel may respond either affirmatively or negatively to the response. If the auxiliary personnel negatively responds, the scheduled personnel may continue polling the auxiliary personnel. Once an auxiliary personnel has positively responded, the substitute request may be sent for approval. In some embodiments, a manager may then have the option of approving or rejecting the request. If the request is approved, the schedule module 320 may receive a notification and update the schedule. If the request is rejected, the scheduled personnel may need to continue polling auxiliary personnel until an acceptable auxiliary personnel is located, confirmed, and approved.

In further embodiments, the list of shift auxiliary options may be published to a manager. The manager may access the auxiliary shift options to request personnel to work when the business experiences an increase in activity. For example, the business may have an increase in customers, sales, or other events that may require the need of additional personnel. The manager may use the list of auxiliary shift options to augment staffing to satisfy the business needs. In some embodiments, the manager may send a work request to the auxiliary personnel. For example, the manager may use the remote device 215 to send a request to the personnel device 210. The personnel may access the request using the personnel module 250 located within the personnel device 210. The personnel may then send a response back to the manager. The response may be positive or negative. If the response is negative, the manager may continue to contact auxiliary personnel until an auxiliary personnel affirmatively responds.

In some embodiments, the publication module 330 may publish a finalized and approved work schedule. If an auxiliary personnel has been requested to work, the publication module 330 may immediately update and publish the new schedule. The publication may be limited to managers, select personnel, or may be published and distributed to the business as a whole. In some embodiments, the schedule may be electronic and personnel may receive an email, text message, or the like containing the schedule. In other embodiments, personnel may access the schedule via the personnel module 250 on the personnel device 210 (FIG. 2). For example, the latest scheduling information may be accessible via a mobile application which may be downloaded to the personnel device 210.

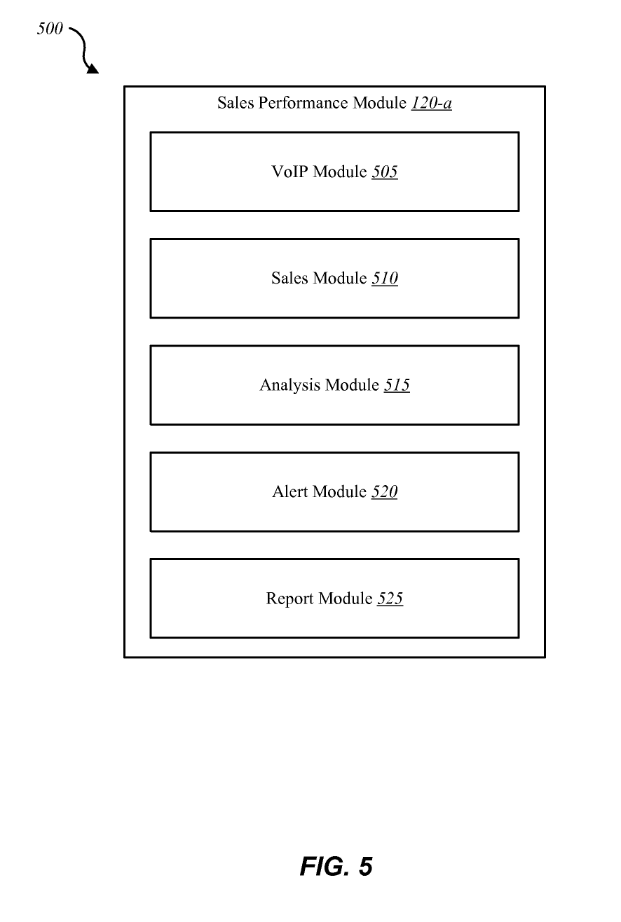

FIG. 5 is a block diagram 500 illustrating one example of a sales performance module 120-a. The sales performance module 120-a may be one example of the sales performance module 120 depicted in FIGS. 1 and/or 2. As depicted, the sales performance module 120-a may include a VoIP module 505, a sales module 510, an analysis module 515, an alert module 520, and a report module 525. Other embodiments may include additional or, in some embodiments, fewer modules than that which is shown in FIG. 5.

In some embodiments, the VoIP module 505 may track, receive, and or record VoIP data. For example, the VoIP module 505 may be equipped to receive information regarding telephonic information. The telephonic information may include a number of calls and call traffic. The call traffic may include call origination, call destination, call-length time, and the like. The call traffic may also track the sales associated with calls. For example, the VoIP module 505 may determine which calls result in sales and the amount of sales. For example, in some instances, only a select number of calls may result in deals. The VoIP module 505 may track this information and record it. In some embodiments, the VoIP module 505 may coordinate with an onsite security system or other such surveillance system.

In some embodiments, the VoIP module 505 may track the origination of the call using unique telephone numbers. For example, a business may partake in a marketing campaign. The marketing campaign may canvas social media, print media, and the like. Each variation of marketing may have a unique telephone number. The unique telephone number may trigger the VoIP module 505 to determine the origination of the sales lead. For example, a customer reading the newspaper may dial a unique number to contact the business and a different customer using social media may use a different unique number. The VoIP module 505 may track the targeted numbers to determine the effectiveness of the marketing campaign.

In another embodiment, the VoIP module 505 may receive input from personnel. For example, the VoIP module 505 may have a user interface that tracks VoIP information in conjunction with data and information input by a personnel. In some embodiments, the personnel may enter information regarding the call. The information may contain sales information or may contain general client information. The VoIP module 505 may determine based on the input whether a personnel is making a sale. For example, as the personnel is speaking to a client or potential customer via the telephone, the VoIP module 505 may automatically open a program on the computing device associated with the phone call. As the personnel walks through different prompts and enters information, the VoIP module 505 may track the information associated with the personnel, the call, and the client.

The sales module 510 may track point of sale information. For example, the sales module 510 may record data regarding customer's purchases including time of day, itemized purchases, correlation to events or sales, payment options, coupons, discounts, and the like. In some embodiments, the sales module 510 may determine a pattern of purchases. For example, a particular client may have a pattern to their purchases or projects or there may be sales patterns associated with clearance events, seasonal events, or the like.

In further embodiments, the sales module 510 may correlate sales and purchases to specific personnel. For example, using the VoIP module 505, the sales module 510 may correlate telephonic sales to personnel who completed the sale. For example, the sales module 510 may compare point of sale information to a work schedule. The work schedule may contain information regarding personnel scheduled to work. The sales module 510 may determine if one or more trends between point of sale data and the work schedule exist. In some embodiments, the trends may capture profits or losses of the business. In further embodiments, sales personnel may receive commission and the sales module 510 may track commissioned sales. In further embodiments, personnel may receive scores such as in a personnel profile. The scores may be affected by the sales completed by the personnel. For example, completing sales may increase the personnel's score. In still further embodiments, the sales may be recorded in a profile associated with the personnel. The sales module 510 may also track client information such as number of sales or projects associated with a client or customer.

In some embodiments, the sales module 510 may also set business metrics. For example, the sales module 510 may determine a certain threshold of sales that should be met daily, weekly, and/or monthly. The threshold may change based on day of the week, time of year, and other factors. For example, sales may be tied to seasonal changes or events such as carnivals, fairs, and the like. Business metrics may also include sales goals for personnel. For example, personnel may be expected to effect a set number of sales over a given time period. The sales of the personnel may be tracked by the personnel profile module 315 (FIG. 3) and/or in combination with the sales module 510.

In some embodiments, the analysis module 515 may gather, interpret and/or analyze information relating to the business. For example, the analysis module 515 may receive and/or gather information relating to VoIP data and sales data (e.g. information from the VoIP module 505 and/or the sales module 510). In further embodiments, the analysis module 515 may also have information from the automated schedule module 110. For example, the analysis module 515 may have shift information, personnel profile information, schedule information, and the like. The analysis module 515 may compare VoIP data and sales information to information from the automated schedule module 110 such as scheduling parameters. In some embodiments, the analysis module 515 may compare VoIP data with at least one metric associated with the business. For example, the analysis module 515 may compare VoIP data with sales data to determine if the VoIP data satisfies or exceeds one or more metrics associated with the business. For example, the business metrics may require marketing campaigns to generate a set number of leads in order to continue the particular marketing campaign. Business metrics may also require personnel to finalize a predetermined number of sales. The VoIP data, combined with point of sale information, may track sales. The analysis module 515 may also compare sales and VoIP data to profit metrics of the business. Profit metrics may include overall profits realized by the business.

The analysis module 515 may realize unpredicted changes in VoIP data and/or point of sale data. For example, the analysis module 515 may have information gathered by the VoIP module 505. The analysis module 515 may compare the gathered information to predicted information. In some embodiments, the analysis module 515 may realize an unpredicted shift in the VoIP data. For example, the VoIP data may exceed historical information whereas certain personnel are not performing up to historical levels or where marketing campaigns are showing a fluctuation in success. For example, personnel may be waning in their performance which may relate to VoIP data such as call-length time, call origination, and the like. Conversely, personnel may be exceeding expectations by realizing more sales or leads on sales.

Additionally, the analysis module 515 may realize a fluctuation in point of sale data wherein an aggregate monetary value or sales or total of sales has changed. The fluctuation may be positive or negative. For example, there could be an increase in aggregate value and total number of sales, vice versa, or the two could have opposing trends. For example, fewer number of sales could be realized but the sales may be larger in volume thus causing an increase in aggregate monetary value or sales. The analysis module 515 may correlate the unpredicted change in point of sale data with VoIP data. For example, trends in VoIP data may cause a direct correlation to sales information. The trends could be a call length time, personnel performing the sale, call volume, or the like. The analysis module 515 may record the changes in a database with the correlating VoIP data. In some embodiments, the analysis module 515 may adjust business metric goals based on the correlating. For example, the analysis module 515 may realize time of day is important for finalizing sales and adjust the business metric goals to effect a larger quantity of sales calls during those time frames. In further embodiments, the correlating may realize certain sales tactics have a greater likelihood of success and change the business metrics to adopt those tactics.

The analysis module 515 may also determine any trends between the point of sale information, VoIP data, and work schedule information. The analysis module 515 may develop trends correlating or attempting to find a relationship between the data. For example, there may be a spike in point of sales when certain VoIP thresholds are met. In further embodiments, certain personnel may have increased sales or decreased sales. The fluctuation in sales may result in capture the trend between profits or losses of the business and the work schedule information. Additionally, trends may develop between select personnel and sales or revenue.

In some embodiments, the analysis module 515 may compare VoIP data to a work schedule. The work schedule may comprise scheduling information for at least one personnel associated with the business. For example, the analysis module 515 may compare VoIP data to the schedule and determine if trends between scheduled personnel and VoIP data or point of sales information are present. For example, certain personnel may function better together or may become inefficient. Additionally, the VoIP data may correlate to an increase in sales when certain personnel are present or other advantageous benefits to the business. In some embodiments, a performance report may be developed based on this comparison. In further embodiments, the performance report may be used to update a profile associated with the at least one personnel. For example, the analysis module 515 may send information to a personnel profile module (e.g. personnel profile module 315) to update a profile associated with the personnel. The updating may include determining a score associated with the personnel based on the comparison between the work schedule and the VoIP data. In some embodiments, the profile may be updated with the determined score.

The alert module 520 may facilitate alerts based on the above described modules and parameters. For example, the alert module 520 may generate and push alerts to various personnel including managers. The alert may be displayed to a manager on a dashboard associated with the business. For example, the alert may be sent to a mobile device associated with the manager. The mobile device may include a user interface enabling the manager to interact with the system. The user interface may be a dashboard. In further embodiments, the alert module 520 may generate an alert when the observed VoIP data satisfies or exceeds one or more metrics associated with the business. The alert may be sent to a manager or other personnel. In some embodiments, the alert module 520 may request an action by the manager. For example, the alert may notify the manager of an increase in call volume has exceeded the capacity of the scheduled staff. The alert may request the manager to approve the inadequacies, or to begin the process to request auxiliary personnel to supplement business needs. The alert module 520 may also generate and/or send alerts as thresholds are encroached or exceeded. For example, if an unexpected increase in VoIP data occurs, the alert module 520 may send an alert to a manager regarding the status of the threshold. The threshold may be exceeded or may be approaching its limitations. In some embodiments, the parameters may be point of sale parameters, VoIP parameters, personnel or staffing parameters. In some embodiments, alerts may be sent to more than one manager or personnel. For example, the alert may be sent to specific shift managers as well as their supervisor. In some embodiments, if call volume is low, the alert may request the manager to release staff early to preserve business profit metrics.

The report module 525 may generate and send out reports based on the information contained within the sales performance module 120-a and sometimes comparisons between business metrics and employee scheduling from the automated schedule module 110. For example, the report module 525 may generate reports tracking VoIP data, sales data, correlations between data, profits, losses, and the like. The reports may be historical, forward looking, or for recent time periods. The reports may be automatically generated or personnel may request specific reports. The reports may contain business metric trends to enable personnel to maximize business profit, or other business goals such as sustainability, reusability, friendliness, and the like. The reports may correlate business metrics to scheduling information and better align the two modules to meet business goals.

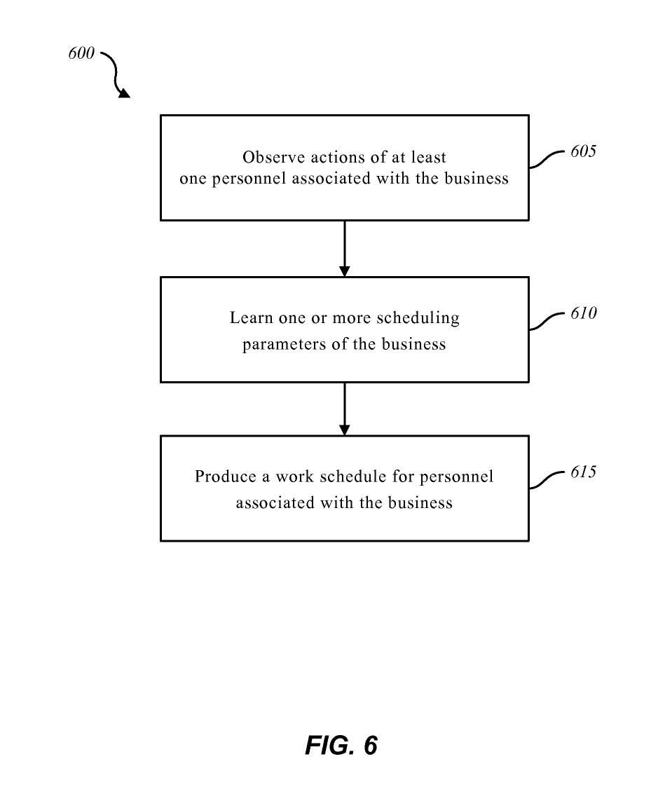

FIG. 6 is a flow diagram illustrating one embodiment of automating work schedule for a business. In some configurations, the method 600 may be implemented by the automated schedule module 110 of the location system 105 shown in FIGS. 1 and/or 2. In other examples, the method 600 may be performed generally by the location system 105 shown in FIGS. 1 and/or 2, or even more generally by the environments 100, 200 shown in FIGS. 1 and/or 2.

At block 605, actions of at least one personnel associated with the business may be observed. For example, one or more personnel may be observed based on their performance, timeliness, reliability and the like. The personnel's arrival and departure times or clock-in and clock-out times may be compared to the scheduled time to determine if the personnel is consistently punctual or tardy. Additionally, the personnel's absences may be observed as well as whether the personnel gave adequate notice for the pending absences. If a particular personnel consistently calls in sick right before their shift starts, the personnel may be flagged as unreliable. In contrast, if a personnel is usually on time for their shift but occasionally gives adequate notice prior to absences, the personnel may be seen as reliable.

In some embodiments, historical information regarding the business may also be observed. For example, seasonal information, market information or previous sales information may be gathered and stored. The information may provide an insight into the functions and fluctuations of the business to provide more well-rounded knowledge. In some embodiments, historical scheduling information may also be observed. For example, historical or previous scheduling information may be input into the system. The historical information may speed up the observation process to provide an automated schedule system. The historical information may reduce the observation and learning period to achieve an automated scheduling system sooner.

In some embodiments, the scheduled personnel and scheduling may be compared to the business metrics. For example, the impact of the personnel, their interaction and scheduling may affect business metrics such as efficiency, profit, waste, sales royalties, customer loyalty, overhead, loss, hours worked per process, and the like. Other aspects of the business may also be observed and recorded. For example, if weather affects the business, severe weather conditions may be tracked such as severe thunderstorms, snowstorms, tornadoes, earthquakes, etc. Additionally, newsworthy events may be observed and recorded if they may impact the particular business. For example, an e. coli outbreak in beef products may negatively impact other producers of unaffected beef. All these type of external events that have the potential to negatively or positively impact the business may be observed and recorded.

At block 610, one or more scheduling parameters of the business may be learned. This may be based on the observations gathered at block 605. For example, all of the observations concerning personnel actions and scheduling may be compared to business metrics and external events to improve scheduling to positively impact the business. For example, a specific number of personnel may result in positive business metrics and reduce waste or loss. The specific number may be a combination of different personnel roles. In some embodiments, a scheduled mixture of personnel expertise may also benefit the business. The mixture of expertise may result in lower overhead costs while still achieving business goals. Additionally, the timing of shift changes or shift overlap may also benefit the business.

At block 615, a work schedule for personnel associated with the business may be produced. The schedule may be based on the learning at block 610 and/or the observations at block 605. The schedule may include a predetermined time period. For example, the schedule may be for the next day, week, two weeks, month, etc. The predetermined time period may be set by the manager, other personnel, or, in some embodiments, if no time period is set, it may default to two weeks.

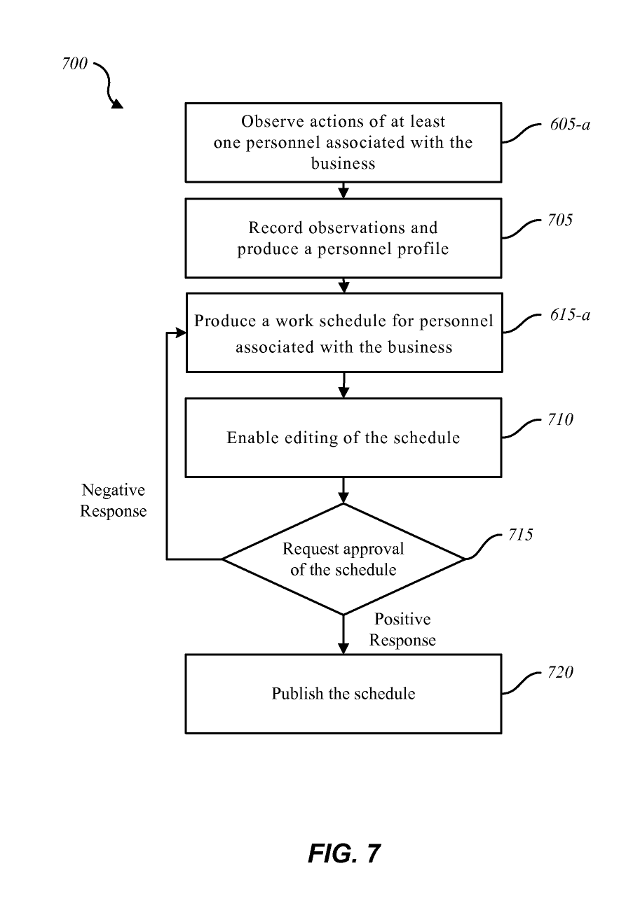

FIG. 7 is a flow diagram illustrating an embodiment of another method 700 for automating personnel scheduling. In some configurations, the method 700 may be implemented by the automated schedule module 110 of the location system 105 shown in FIGS. 1 and/or 2. In other examples, the method 700 may be performed generally by the location system 105 shown in FIGS. 1 and/or 2. Even still more generally, the method 700 may be performed generally by the environments 100, 200 shown in FIGS. 1 and/or 2.

At block 605-a, the personnel actions and scheduling may be observed. Then, at block 705, the observations may be recorded and personnel profile may be produced. For example, in some embodiments, the observations may be used to generate a personnel profile. The personnel profile may include the personnel's contact information, role, experience, number of sick days taken, number of vacations taken, achieved skill levels, pay-scale, and the like. In some embodiments, the personnel profile may also include a personnel score. For example, the personnel may have a rating based on their performance among other factors. The rating may reflect amount of experience, skills, absences, efficiency, or some combination thereof. The rating may also reflect additional information relevant to the personnel's performance or pay-scale. Each factor may have an individual factor score or rating. The factor score may be summed up to a total score, or may be averaged into an overall score. For some business, the score may be a numeric score. It may be on a small scale, such as 1-10, or may be on a much higher scale such as 1-100. In other embodiments, the rating may be a series of named levels such as beginner, novice, intermediate, advanced, and expert. Different scoring methods may be available. In some embodiments, the scoring methods may be unique and customized to particular businesses.

At block 615-a, a work schedule for personnel associated with the business may be produced. The schedule may be based upon the personnel score. For example, personnel with preferential scores may receive more desirable shifts, working hours, or vacation days. In some embodiments, the schedule may contain shifts with personnel of predetermined skill levels. For example, the shift may include five personnel, and at least one personnel may be from the “expert” range, and only one personnel may be from the “beginner” range. By varying the expertise and/or rating of the personnel, the schedule may maximize business metrics and personnel learning. For example, the schedule may balance the expertise and/or ranking of the personnel with the pay-scale associated with the personnel to maximize for business profit. Additionally, by using the different rankings and ratings, the schedule may prevent scheduling multiple unreliable personnel for the same shift. This may prevent an understaffed shift due to multiple absences. In some embodiments, a manager or other personnel associated with the business may set the personnel score distribution or requirements for each shift.

At block 710, the schedule may be edited. For example, the schedule created at block 615-a may be published only to select personnel such as a manager. The manager may have the ability to change aspects of the schedule. In some embodiments, any aspect of the schedule may be changed or edited. For example, staffing for shifts may be increased or decreased. The timing of shifts or the personnel scheduled may be changed. In some embodiments, no changes may be necessary.

Once the editing is complete, at block 715, the approval of the schedule may be requested. If the schedule is rejected, a new schedule may be created at block 615-a. For example, the schedule may be rejected and a request for a new schedule may be generated. In other embodiments, the rejection may provide feedback as to why the schedule was rejected so a more desirable schedule can be produced. In some embodiments, an overall schedule change request or specific changes to the schedule may be requested. Changes may be observed and recorded as part of a learning module (e.g. learning module 310). In other embodiments, the changes may be requested due to pending events. For example, the business may have pending deadline such as the tax deadline, an increase in sales due to a convention or product release, or some other event. This feedback may be provided with the rejection and a new schedule may be generated at block 615-a.

If the schedule is approved, at block 720, the schedule may be published. For example, the schedule may be electronic and may be distributed to various business personnel. The schedule may be distributed via text message, email, online, and the like. In some embodiments, the schedule may be sent to a mobile device associated with the personnel (e.g., personnel device 210 and/or remote device 215). For example, the mobile device may have an application which may access the schedule. In further embodiments, a hard copy of the schedule may be created and distributed to personnel.

In some embodiments, other steps of method 700 may include portions of the method 600. In other embodiments, the method 700 may include receiving requesting time-off from personnel. For example, the personnel may submit requested vacation days or specific days off. The schedule may be additionally based on these personnel preferences.

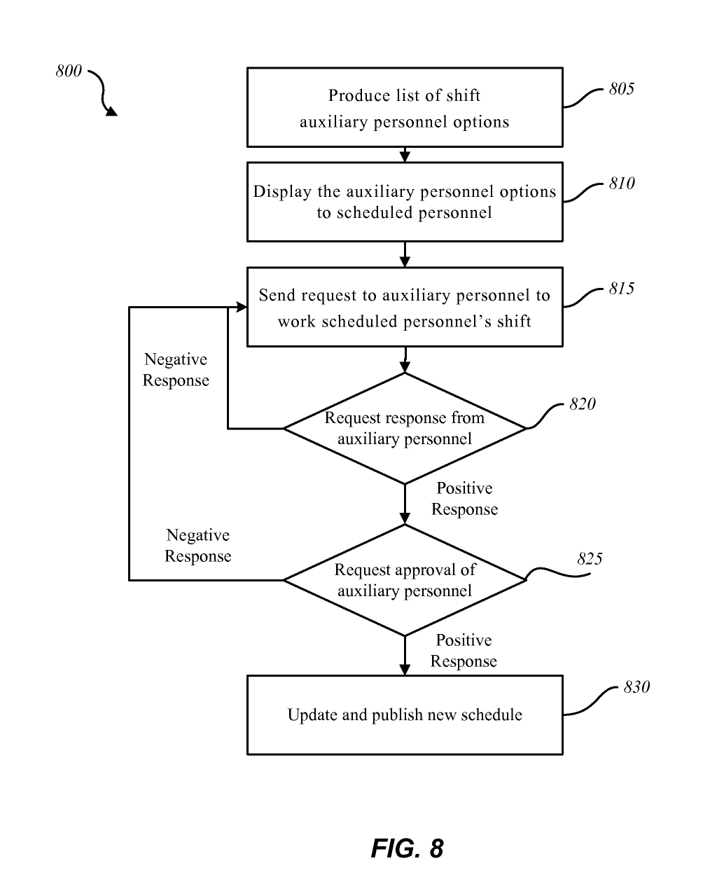

FIG. 8 is a flow diagram illustrating an embodiment of a method 800 for finding auxiliary personnel. In some configurations, the method 800 may be implemented by the automated schedule module 110 of the location system 105 shown in FIGS. 1 and/or 2. In other examples, the method 800 may be performed generally by the location system 105 shown in FIGS. 1 and/or 2. Even still more generally, the method 800 may be performed generally by the environments 100, 200 shown in FIGS. 1 and/or 2. In some embodiments, other steps of method 800 may include portions of the method 600 and/or 700.

At block 805, a list of shift auxiliary personnel options may be produced. For example, when the schedule is generated, certain personnel may not be scheduled to work but may be listed as available to work. The list of shift auxiliary personnel may include alternative personnel to replace a scheduled personnel. The list may be specific to personnel roles. For example, the list may be specific to engineers, human resources, accounting, etc. Each role within a business may be defined and the list may include alternative personnel for each shift. In some embodiments, the lists may only contain desirable personnel. For example, if personnel have a score associated with them, the list may only comprise personnel who have achieved and/or maintained a certain score or proficiency level or surpassed a threshold. In still further embodiments, the list of auxiliary personnel may be specific to the scheduled personnel. For example, the list may only contain alternative personnel with the same ranking and/or proficiency level with the same personnel role. Additionally, the list may be specific for the shift or may be a generic auxiliary list for any timeframe. In some embodiments, if the list is a generic list, personnel may need to achieve a predetermined proficiency level or score in order to join the list.

At block 810, the auxiliary personnel options may be displayed to the scheduled personnel. For example, the list may be electronic and may be distributed to scheduled personnel. If the list is a generic list, it may be generally distributed and always available. The electronic list may be distributed and/or available via email, online, or via a mobile phone. For example, an application downloaded onto a mobile device may access the list of auxiliary personnel. In other embodiments, the list may be printed and available in a hardcopy. The hardcopy may be displayed onsite at the business, or may be distributed among personnel.

At block 815, if a personnel has a conflict and cannot work, the personnel may send a request to an auxiliary personnel to work the scheduled personnel's shift. For example, the scheduled personnel may be unable to work and may view the list of auxiliary personnel. The scheduled personnel may contact auxiliary personnel and ask the auxiliary personnel to fill in. The request may be sent via the mobile application on the personnel's mobile devices, or may be sent via other means such as a phone call, email, SMS, or the like. At block 820, a response from the auxiliary personnel may be requested. If the auxiliary personnel provides a negative response, at block 815, the scheduled personnel may start the process over.

However, if the auxiliary personnel provides a positive response, at block 825, an approval for the auxiliary personnel may be requested. For example, an approval request may be sent to a manager of the scheduled personnel. If the auxiliary personnel is not approved, the scheduled personnel may need to start the process over at block 815. For example, the auxiliary personnel may not have the same proficiency level or skillset as the scheduled personnel. The auxiliary personnel may also extend into overtime pay, which may cause the rejection of the auxiliary personnel. Other reasons for rejecting the request may also exist. Feedback may be provided to enable the scheduled personnel to find a better suited auxiliary. If the request is approved, at block 830, the schedule may be updated and a new schedule may be published.

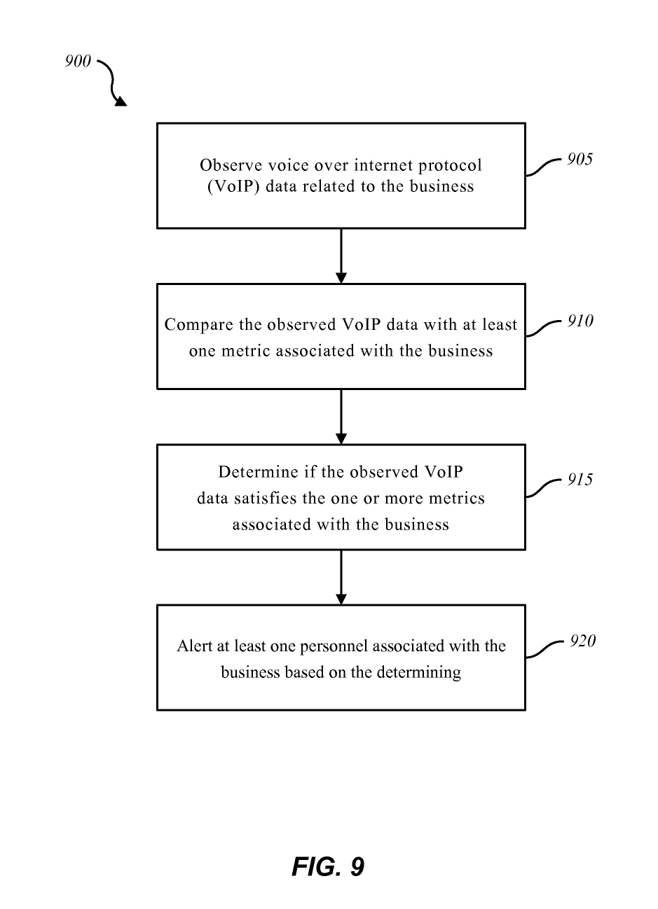

FIG. 9 is a flow diagram illustrating an embodiment of a method 900 for automating sales performance analysis. In some configurations, the method 900 may be implemented by the sales performance module 120 of the location system 105 shown in FIGS. 1 and/or 2. In other examples, the method 900 may be performed generally by the location system 105 shown in FIGS. 1 and/or 2. Even still more generally, the method 900 may be performed generally by the environments 100, 200 shown in FIGS. 1 and/or 2. In some embodiments, other steps of method 900 may include portions of the methods 600, 700, and/or 800.

At block 905, voice over internet protocol (VoIP) data related to the business may be observed. The data may comprise at least one of a call-length time, calling number, call origination, call destination, call volume or other call metadata. In some embodiments, VoIP data may be observed relating to personnel. For example, personnel making a phone call, sale, or the like. The VoIP data may correlate different incoming calls to marketing campaigns. For example, marketing campaigns may have targeted telephone numbers to determine the origination of the business lead. Likewise, sales personnel may have unique telephonic identifiers to associate with generated business leads.

At block 910, the observed VoIP data may be compared with at least one metric associated with the business. The business metric may comprise point of sale metrics, personnel metrics or profit metrics of the business. For example, the VoIP data may be compared to different point of sale metrics to determine correlations between the two. For example, different marketing campaigns may lead to different sales generation. A social media marketing campaign may generate a younger clientele which may purchase unique items compared to an newspaper article which may generate an older generation of clientele seeking alternative products. For example, an accountant may need to help younger clientele with budget management and student debt payoff advise whereas an older client may wish to determine how to effectively draw from retirement accounts and how to best approach retirement. The personnel metrics may be compared to VoIP data to determine the effectiveness of the personnel in completing a sale or other quantifiable measurement. For example, each personnel may have a unique phone line using VoIP parameters. The VoIP data may be observed and compared to the performance of the personnel.

At block 915, it may be determined if the observed VoIP data satisfies the one or more metrics associated with the business. For example, the business may have a metric requiring personnel to complete a certain number of calls per day, sales per month, or generate a set number of business leads. Additionally, the business may require certain marketing campaigns to generate a set amount of leads. The business may also have metrics surrounding the number of sales or profit margins that must be met. All of the business metrics are compared to the VoIP data to determine if the metrics have been satisfied.

At block 920, at least one personnel associated with the business may be alerted when the VoIP data satisfies the one or more metrics associated with the business. In some embodiments, the alert may be sent to a manager of the business. For example, an alert may be generated and sent to a mobile device associated with the personnel. The alert may be an email, ping, SMS, voicemail or the like. The alert may relate when certain thresholds have been or exceed or when thresholds are reaching their limit. Alerts may additionally contain information regarding scheduling issues, unusual or unpredicted VoIP fluctuations, sales fluctuations, and the like. Alerts may also include information regarding staffing shortage. For example, an increase in call volume may cause a need to auxiliary staffing. In some embodiments, the alerts may automatically be generated to auxiliary personnel to replace absent staff or to augment staffing to satisfy business needs.

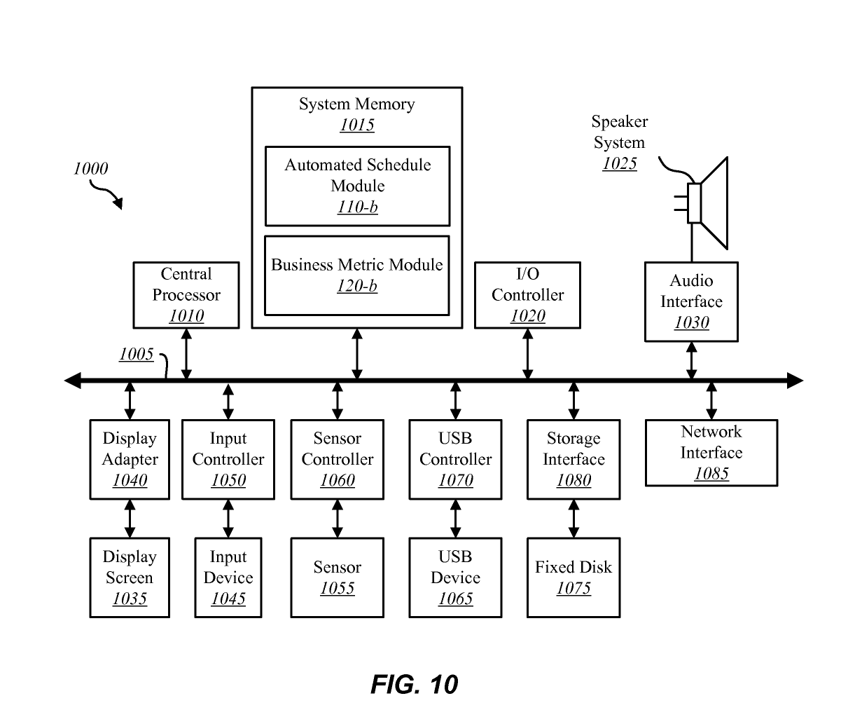

FIG. 10 depicts a block diagram of a computer system 1000 suitable for implementing the present systems and methods. The computer system 1000 may be an example of the mobile computing device 225, the remote device 215, the personnel device 210, the database 220, and/or some combination thereof illustrated in FIG. 2. In one configuration, the computer system 1000 may include a bus 1005 which interconnects major subsystems of the computer system 1000, such as a central processor 1010, a system memory 1015 (typically RAM, but which may also include ROM, flash RAM, or the like), an input/output controller 1020, an external audio device, such as a speaker system 1025 via an audio output interface 1030, an external device, such as a display screen 1035 via display adapter 1040, an input device 1045 (e.g., remote control device interfaced with an input controller 1050), multiple USB devices 1065 (interfaced with a USB controller 1070), and a storage interface 1080. Also included are at least one sensor 1055 connected to bus 1005 through a sensor controller 1060 and a network interface 1085 (coupled directly to bus 1005).

The bus 1005 may allow data communication between the central processor 1010 and the system memory 1015, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, an automated schedule module 110-b and/or a sales performance module 120-b to implement the present systems and methods may be stored within the system memory 1015. Applications (e.g., application 230) resident with the computer system 1000 are generally stored on and accessed via a non-transitory computer readable medium, such as a hard disk drive (e.g., fixed disk drive 1075) or other storage medium. Additionally, applications can be in the form of electronic signals modulated in accordance with the application and data communication technology when accessed via the network interface 1085.

The storage interface 1080, as with the other storage interfaces of the computer system 1000, can connect to a standard computer readable medium for storage and/or retrieval of information, such as a fixed disk drive 1075. The fixed disk drive 1075 may be a part of the computer system 1000 or may be separate and accessed through other interface systems. The network interface 1085 may provide a direct connection to a remote server via a direct network link to the Internet via a POP (point of presence). The network interface 1085 may provide such connection using wireless techniques, including digital cellular telephone connection, Cellular Digital Packet Data (CDPD) connection, digital satellite data connection, or the like.

Many other devices or subsystems (not shown) may be connected in a similar manner (e.g., documents scanners, digital cameras, and so on). Conversely, all of the devices shown in FIG. 10 need not be present to practice the present systems and methods. The devices and subsystems can be interconnected in different ways from that shown in FIG. 10. The aspect of some operations of a system such as that shown in FIG. 10 are readily known in the art and are not discussed in detail in this application. Code to implement the present disclosure can be stored in a non-transitory computer-readable medium such as one or more of system memory 1015 or fixed disk drive 1075. The operating system provided on the computer system 1000 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method to automate sales performance analysis for a business, comprising:
observing voice over internet protocol (VoIP) data related to the business, the VoIP data comprising at least one of a call-length time, a calling number, a call origination, a call destination, a call volume, or a call metadata;
comparing the observed VoIP data with at least one metric associated with the business, the metric based at least in part on one or more point of sale metrics, personnel metrics, or profit metrics of the business; and
determining if the observed VoIP data satisfies the one or more metrics associated with the business; and
alerting at least one personnel associated with the business based at least in part on the determining.

2. The computer-implemented method of claim 1, further comprising:
capturing point of sale data, wherein point of sale comprises at least one of items or services purchased, an amount of the purchase, a time of the purchase, and a discount or sale associated with purchase;
comparing the point of sale data to the observed VoIP data;
correlating the VoIP data to the point of sale data based on the comparing; and
generating a report outlining correlations.

3. The computer-implemented method of claim 1, further comprising:
comparing the VoIP data to a work schedule, the work schedule comprising at least scheduling information for one personnel associated with the business, and
developing a performance report based on the comparing.

4. The computer-implemented method of claim 4, further comprising:
updating a profile associated with at the least one personnel based on the developing; and
determining a score associated with the updating; and
updating the profile associated with the at least one personnel based on the determined score.

5. The computer-implemented method of claim 1, further comprising:
recording the VoIP data based on the observing;
generating at least one report based on the recording; and
distributing the at least one report to the at least one personnel associated with the business.

6. The computer-implemented method of claim 1, further comprising:
determining if the observed VoIP data exceeds the one or more metrics associated with the business; and
alerting the at least one personnel associated with the business based at least in part on the determining.

7. The computer-implemented method of claim 1, further comprising:
identifying an unpredicted change in point of sale data, wherein the change comprises one of a fluctuation in an aggregate monetary value of sales or a total number of sales;
correlating the unpredicted change in point of sale data with the VoIP data; and
recording the unpredicted change in a database with the correlating VoIP data.

8. The computer-implemented method of claim 8, further comprising:
adjusting business metric goals based at least in part on the correlating.

9. The computer-implemented method of claim 8, furthering including reviewing the database for historical information;
generating a report to send to the at least one personnel associated with the business, wherein the report contains the historical information for an upcoming time period.

10. The computer-implemented method of claim 1, further comprising
capturing point of sale data, wherein the point of sale data includes items purchased, cost of items purchased, and relationship of items purchased to each other;
comparing the point of sale data to a work schedule;
determining one or more trends between the point of sale data and the work schedule, wherein the one or more trends captures profits or losses of the business.

11. The computer-implemented method of claim 1, wherein alerting the at least one personnel further comprises:
alerting a supervisor of the business based on the determining, wherein alerting the supervisor comprises displaying an alert on a dashboard associated with the business.

12. The computer-implemented method of claim 1, wherein the business metrics further comprise at least one of a number of sales, a change in sales, a profit, or a volume of calls based on daily, weekly, or monthly totals.

13. An apparatus to automate sales performance analysis for a business, comprising:
a processor;
a memory in electronic communication with the processor; and
instructions stored in the memory, the instructions being executable by the processor to:
observe voice over internet protocol (VoIP) data related to the business, the VoIP data comprising at least one of call-length time, calling number, call origination, call destination, call volume, or call metadata;
compare the observed VoIP data with at least one metric associated with the business, the at least one metric based at least in part on one or more point of sale metrics, personnel metrics, or profit metrics of the business; and
determine if the observed VoIP data satisfies the one or more metrics of the business; and
alert at least one personnel associated with the business based at least in part on the determine step.

14. The apparatus of claim 13, wherein the instructions are executable by the processor to:
capture point of sale data, wherein point of sale comprises at least one of items or services purchase, amount of purchase, time of purchase, and discounts or sales associated with purchase;
compare the point of sale data to the observed VoIP data;
correlate the VoIP data to the point of sale data based on the comparison; and
generate a report outlining correlations.

15. The apparatus of claim 13, wherein the instructions are executable by the processor to:
compare the VoIP data to a work schedule, the work schedule comprising at least scheduling information for one personnel associated with the business, and
develop a performance report comprising the comparison.

16. The apparatus of claim 13, wherein the instructions are executable by the processor to:
identify an unpredicted change in the point of sale data, wherein the change comprises one of a fluctuation in the amount of purchases or the total number of purchases;
correlate the unpredicted change in point of sale data with the VoIP data; and
record the unpredicted change in a database with the correlating VoIP data.

17. The apparatus of claim 13, wherein the instructions are executable by the processor to:
alerting a supervisor of the business based on the determining step when the VoIP data exceeds the one or more business metrics, wherein alerting the supervisor comprises displaying an alert on a dashboard associated with the business.

18. A computer-program product to automate sales performance analysis for a business, the computer-program product comprising a non-transitory computer-readable medium storing instructions executable by a processor to:
observe voice over internet protocol (VoIP) data related to the business, the VoIP data comprising at least one of call-length time, calling number, call origination, call destination, call volume, or call metadata;
compare the observed VoIP data with at least one metric associated with the business, the metric based at least in part on one or more point of sale metrics, personnel metrics, or profit metrics of the business; and
determine if the observed VoIP data satisfies the one or more metrics of the business; and
alert at least one personnel associated with the business based at least in part on the determine step.

19. The computer-program product of claim 18, wherein the instructions are executable by the processor to:
capture point of sale data, wherein point of sale comprises at least one of items or services purchase, amount of purchase, time of purchase, and discounts or sales associated with purchase;
compare the point of sale data to the observed VoIP data;
correlate the VoIP data to the point of sale data based on the comparison; and
generate a report outlining correlations.

20. The computer-program product of claim 18, wherein the instructions are executable by the processor to:
compare the VoIP data to a work schedule, the work schedule comprising at least scheduling information for one personnel associated with the business, and
develop a performance report comprising the comparison.
